(19) United States
(12) Patent Application Publication
(10) Pub. No.: US 2009/0084454 A1
(43) Pub. Date: Apr. 2, 2009

(54) APPARATUS FOR FIXING HYDRAULIC PIPES FOR ZERO TAIL SWING EXCAVATOR

(75) Inventors: Young Jin SON, Changwon-si (KR); Joon Seog Go, Changwon-si (KR)

Correspondence Address: LADAS & PARRY LLP, 26 WEST 61ST STREET, NEW YORK, NY, 10023, US

(73) Assignee: VOLVO CONSTRUCTION EQUIPMENT HOLDING SWEDEN AB.

(21) Appl. No.: 12/237,407

(22) Filed: Sep. 25, 2008

(30) Foreign Application Priority Data
Oct. 1, 2007 (KR) 10-2007-0098708
Dec. 10, 2007 (KR) 10-2007-0127656

(51) Int. Cl. E02F 9/22; E02F 3/36; F16L 35/00; F16L 3/00

(52) U.S. Cl. 137/899; 285/62; 137/899.4

(57) ABSTRACT

An apparatus for fixing hydraulic pipes for a zero tail swing excavator is provided, which can simplify an assembling process of hydraulic pipes and improve the workability by dividedly forming intermediate sides of the hydraulic pipes for supplying hydraulic fluid from a main control valve to hydraulic cylinders and jointly fixing the dividedly formed intermediate sides of the hydraulic pipes by a connection means in a narrow space between a boom and an upper swing structure due to the characteristic of the zero tail swing excavator. The apparatus for fixing hydraulic pipes includes a lower driving structure; an upper swing structure mounted on the lower driving structure to be swiveled; working devices fixed to the upper swing structure and having a boom, an arm, and a bucket driven by their hydraulic cylinders; boom fixing frames which are mounted on the upper swing structure and to which the boom is rotatably fixed; main pipes for supplying hydraulic fluid to the hydraulic cylinders, intermediate sides of the main pipes being dividedly formed and being jointly connected by a socket; and a bracket for fixing the main pipes, which is fixed to the boom fixing frames and to which the socket is fixed.

### CROSS-REFERENCE TO RELATED APPLICATION

This application is based on and claims priority from Korean Patent Application No. 10-2007-0098708 and 10-2007-0127656, filed on Oct. 1, 2007 and Dec. 10, 2007, respectively in the Korean Intellectual Property Office, the disclosure of which is incorporated herein in its entirety by reference.

### BACKGROUND OF THE INVENTION

1. Field of the Invention

The present invention relates to an apparatus for fixing hydraulic pipes for a zero tail swing excavator, which facilitates assembling and fixing of hydraulic pipes having a large diameter (e.g. main pipes) in a narrow space between a boom and an upper swing structure due to the characteristic of the zero tail swing excavator.

More particularly, the present invention relates to an apparatus for fixing hydraulic pipes for a zero tail swing excavator, which can improve the workability by shortening a work time through simplification of an assembling process of the hydraulic pipes in a manner that intermediate sides of the hydraulic pipes are dividedly formed and are jointly connected by a connection means (e.g. a socket, a block, and the like).

2. Description of the Prior Art

Generally, a swing excavator is classified into a standard swing excavator and a zero tail swing excavator.

In the standard swing excavator, if an upper swing structure has a posture directed to a forward/backward direction against a lower driving structure (i.e. if a working device has a posture directed to the traveling direction of the lower driving structure), a rear end part of the upper swing structure projects to an outside so as to be longer than a front/rear part of the lower driving structure (i.e. an end part in a traveling direction). If the upper swing structure has a posture directed to a horizontal direction against the lower driving structure (i.e. if the working device has a posture directed to a direction perpendicular to the traveling direction of the lower driving structure), the rear end part of the upper swing structure projects to an outside so as to be longer than a left/right part of the lower driving structure (i.e. an end part in a direction perpendicular to the traveling direction).

Accordingly, since a distance from the rear end part of the upper swing structure to the swing center thereof is long and the rotational moment of the rear part of the upper swing structure becomes high, it is difficult that the rotational moment of the front part of the upper swing structure that is generated by the excavation force of the working device causes the overturning of the excavator. Accordingly, the excavator can provide a large excavation force, and thus the workability is improved.

As illustrated in FIG. 1, in the zero tail swing excavator, if the upper swing structure 2 has a posture directed to a forward/backward direction against the lower driving structure 1, the rear end part of the upper swing structure 2 is included in the front/rear part of the lower driving structure 1. If the upper swing structure 2 has a posture directed to the horizontal direction against the lower driving structure 1, the rear end part of the upper swing structure 2 is included in the left/right part of the lower driving structure 1.

In the drawing, unexplained reference numeral A denotes a working device, such as a boom, an arm, or a bucket, which is driven by a hydraulic cylinder, and B denotes a cab mounted on the upper swing structure 2.

Accordingly, since the rear end part of the upper swing structure 2 is included in the front/rear part and the left/right parts of the lower driving structure 1, it does not interfere with an obstacle near the lower driving structure 1, so that the stability is secured during the swing operation, and the operator's swing manipulation becomes excellent. Even if an obstacle exists near the lower driving structure 1, the upper swing structure 2 can perform the swing operation, and this facilitates the work in a narrow space.

In this case, the terms “front/rear part” and “left/right part” mean the direction or side based on the operator in the cab.

As illustrated in FIG. 2, according to the zero tail swing excavator, a space between a boom 3 and an inside of an upper swing structure is relatively small and narrow due to the characteristic of the zero tail swing excavator.

Accordingly, if the boom 3 ascends at maximum height or descends in a state where main pipes 4 (of which the diameter is relatively large) and option pipes 5 are fixed to an upper surface of the boom 3, the option pipes 5 fixed to the upper surface of the boom 3 interfere with neighboring components, such as a swing motor and so on, mounted on the upper swing structure, and thus their assembling is impossible.

In consideration of this problem, the hydraulic pipes are fixed between a main control valve (not illustrated) and the boom 3 by fixing a separate clamp 6 to a side surface of the boom 3, without fixing the main pipes 4 and the option pipes 5 to the upper surface of the boom 3.

In this case, if the number of the main pipes 4 and the option pipes 5 are plural so that diverse option devices, such as quick/fit, breaker, and the like, can be replaced and used in accordance with working conditions, it is difficult to install such pipes.

That is, since a sufficient space cannot be secured except for the inside of the upper swing structure or the circumference of the main control valve, all kinds of main pipes and option pipes are installed in the neighborhood of the boom and the main control valve. In this case, due to the shape of a cover that is fastened to the main control valve to protect the main control valve, a sufficient space for installing the main pipes and the option pipes therein cannot be secured.

Also, since the main pipes and the option pipes are installed in the neighborhood of the boom and the main control valve, the external appearance of the equipment is crude. Also, since the hydraulic pipes are installed beside the boom, passing through frames of the upper swing structure, the work for assembling and installing the hydraulic pipes is laborious to lower the workability.

In addition, in order to improve the working efficiency of the equipment, the zero tail swing equipment has gradually become large-scaled. Accordingly, as the length and the diameter of the hydraulic pipes have been extended, the weight of the hydraulic pipes has also become heavier.

As described above, according to the conventional zero tail swing excavator, two to three workers are required in fixing hydraulic pipes to a unit body, and thus the working efficiency is lowered. Particularly, in the case of working in a narrow space due to the characteristic of the zero tail swing equipment, it is difficult for the worker to handle the hydraulic pipes, and thus the safety of the worker cannot be secured.

### SUMMARY OF THE INVENTION

Accordingly, the present invention has been made to solve the above-mentioned problems occurring in the prior art, and an object of the present invention is to provide an apparatus for fixing hydraulic pipes for a zero tail swing excavator, which can improve the workability in fixing the hydraulic pipes to the zero tail swing excavator, by simplifying an assembling process of the hydraulic pipes in a manner that intermediate sides of the hydraulic pipes are dividedly formed and are jointly connected by a connection means (e.g. a socket, a block, and the like).

Another object of the present invention is to provide an apparatus for fixing hydraulic pipes for a zero tail swing excavator, which can shorten a work time and secure safety of a worker by simplifying a work process for assembling and installing main pipes having a large diameter in a narrow space between a boom and an upper swing structure due to the characteristic of the zero tail swing excavator.

Still another object of the present invention is to provide an apparatus for fixing hydraulic pipes for a zero tail swing excavator, in which, in the case of fixing option pipes to working devices so that the option devices can be replaced and used in the working device in accordance with working conditions, the radius of curvature of the option pipes becomes minimized, and thus various kinds of option pipes can be installed and assembled in a narrow space of an upper swing structure.

In order to accomplish these objects, there is provided an apparatus for fixing hydraulic pipes for a zero tail swing excavator including a lower driving structure, an upper swing structure mounted on the lower driving structure to be swiveled, and working devices fixed to the upper swing structure and having a boom, an arm, and a bucket driven by their hydraulic cylinders, according to an embodiment of the present invention, which comprises boom fixing frames which are mounted on the upper swing structure and to which the boom is rotatably fixed; main pipes for supplying hydraulic fluid to the hydraulic cylinders, intermediate sides of the main pipes being dividedly formed and being jointly connected by a socket; and a bracket for fixing the main pipes, which is fixed to the boom fixing frames and to which the socket is fixed.

In a preferred embodiment of the present invention, the bracket for fixing the main pipes is mounted on outer surfaces of the boom fixing frames.

In another aspect of the present invention, there is provided an apparatus for fixing hydraulic pipes for a zero tail swing excavator including a lower driving structure, an upper swing structure mounted on the lower driving structure to be swiveled, and working devices fixed to the upper swing structure and having a boom, an arm, and a bucket driven by their hydraulic cylinders, which comprises boom fixing frames which are mounted on the upper swing structure and to which the boom is rotatably fixed; and a block for fixing main pipes, fixed to the boom fixing frames, for supplying hydraulic fluid to the hydraulic cylinders and jointly connecting the main pipes of which intermediate sides are dividedly formed.

In a preferred embodiment of the present invention, the block for fixing the main pipes is mounted on outer surfaces of the boom fixing frames.

In still another aspect of the present invention, there is provided an apparatus for fixing hydraulic pipes for a zero tail swing excavator including a lower driving structure, an upper swing structure mounted on the lower driving structure to be swiveled, and working devices fixed to the upper swing structure and having a boom, an arm, and a bucket driven by their hydraulic cylinders, which comprises boom fixing frames which are mounted on the upper swing structure and to which the boom is rotatably fixed; and a bracket for fixing option pipes, which is fixed to the boom fixing frames and to which hydraulic pipes for option devices are fixed; wherein, if the boom ascends at its maximum height or descends, a radius of curvature of the hydraulic pipes for option devices which are fixed to the bracket for fixing the option pipes neighbors a fixing pin of the boom to be minimized.

In a preferred embodiment of the present invention, the hydraulic pipes for option devices are jointly connected by a separate block, and are fixed to the bracket for fixing the option pipes.

The hydraulic pipes for option devices are jointly connected by a separate connector, and are fixed to the bracket for fixing the option pipes.

The hydraulic pipes for option devices are fixed to either of upper surfaces or bottom surfaces of the boom fixing frames.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view of a general zero tail swing excavator;

FIG. 2 is a view illustrating the installation state of hydraulic pipes for a conventional zero tail swing excavator;

FIG. 3 is a schematic view of an apparatus for fixing hydraulic pipes for a zero tail swing excavator according to an embodiment of the present invention;

FIG. 4 is a schematic view illustrating the use state of an apparatus for fixing hydraulic pipes for a zero tail swing excavator according to an embodiment of the present invention;

FIG. 5 is a schematic view of an apparatus for fixing hydraulic pipes for a zero tail swing excavator according to another embodiment of the present invention;

FIG. 6 is a side view of an apparatus for fixing hydraulic pipes for a zero tail swing excavator according to still another embodiment of the present invention; and

FIG. 7 is a perspective view of an apparatus for fixing hydraulic pipes for a zero tail swing excavator according to still another embodiment of the present invention.

### DETAILED DESCRIPTION OF THE PREFERRED EMBODIMENTS

Hereinafter, preferred embodiments of the present invention will be described with reference to the accompanying drawings. The matters defined in the description, such as the detailed construction and elements, are nothing but specific details provided to assist those of ordinary skill in the art in a comprehensive understanding of the invention, and thus the present invention is not limited thereto.

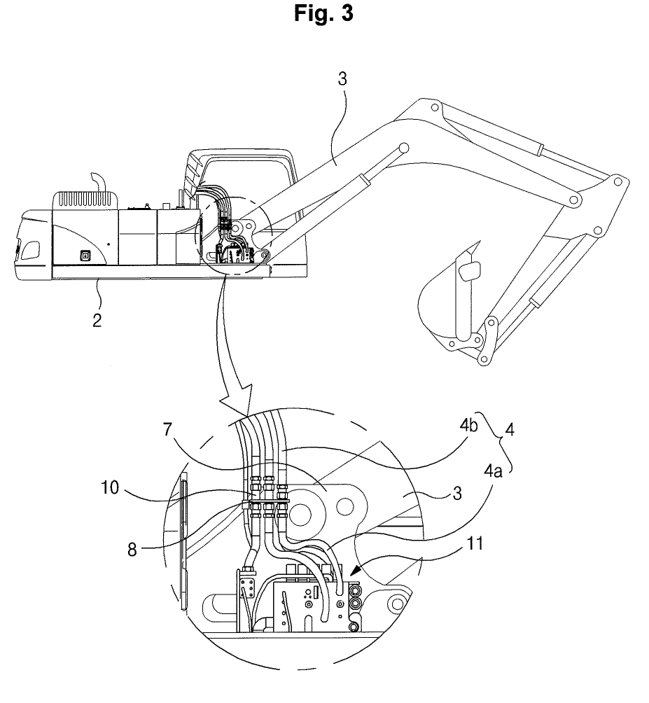

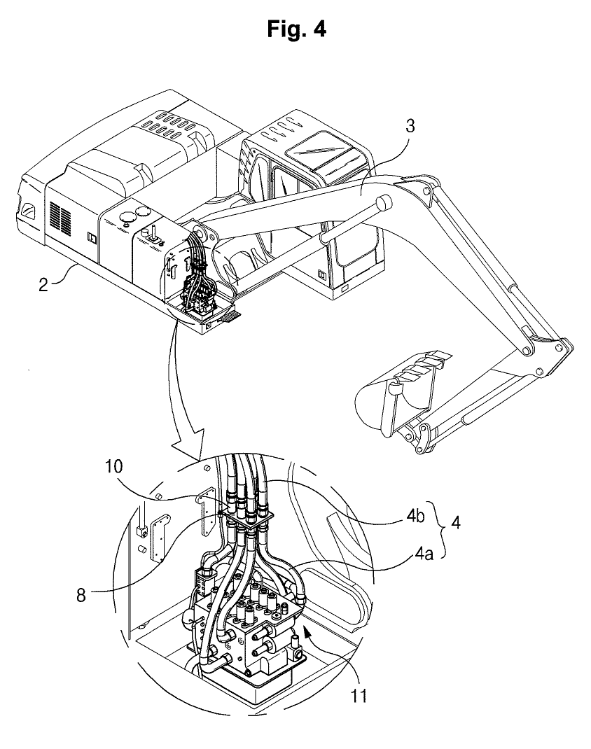

As shown in FIGS. 3 and 4, an apparatus for fixing hydraulic pipes for a zero tail swing excavator according to an embodiment of the present invention includes a lower driving structure, an upper swing structure mounted on the lower driving structure to be swiveled, and working devices fixed to the upper swing structure and having a boom, an arm, and a bucket driven by their hydraulic cylinders. The apparatus further includes a pair of boom fixing frames 7 which are mounted on the upper swing structure 2 and to which the boom 3 is rotatably fixed; main pipes 4 (4a and 4b) for supplying hydraulic fluid to the hydraulic cylinders, intermediate sides of the main pipes being dividedly formed and being jointly connected by a socket 10; and a bracket 8 for fixing the main pipes, which is fixed to the boom fixing frames 7 and to which the socket 10 is fixed.

The bracket 8 for fixing the main pipes may be mounted on outer surfaces of the boom fixing frames 7.

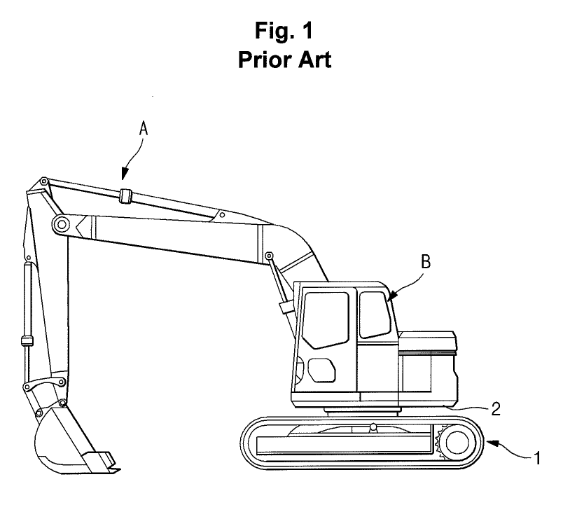

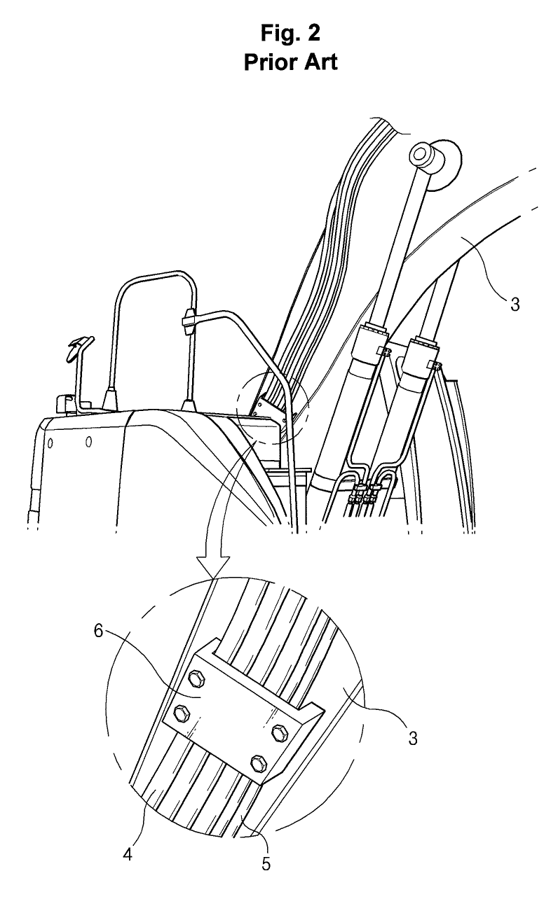

In this case, the construction except for the boom fixing frames 7 mounted on the upper swing structure 2 and the bracket 8 for fixing the main pipes, to which the socket 10 for jointly connecting the main pipes 4 dividedly formed is fixed, is substantially the same as the construction of the conventional zero tail swing excavator as illustrated in FIGS. 1 and 2, and thus the detailed description thereof will be omitted. In the following description of the present invention, the same drawing reference numerals are used for the same elements across various figures.

Hereinafter, the operation of the apparatus for fixing hydraulic pipes for a zero tail swing excavator according to an embodiment of the present invention will be described in detail with reference to the accompanying drawings.

As illustrated in FIGS. 3 and 4, the bracket 8 for fixing the main pipes is fixed to one surface (i.e. an outer surface) of the boom fixing frame 7 mounted on the upper swing structure 2 so that the boom fixing frame 7 is positioned between the main control valve 11 and the boom 3.

An upper end of the main pipe 4a, of which the lower side is jointly connected to the main control valve side 11, is jointly connected to the socket 10 that is fixed to the bracket 8 for fixing the main pipe. Also, a lower end of the main pipe 4b, of which the upper side is fixed to the boom 3, is jointly connected to the socket 10 so as to supply hydraulic fluid to the arm cylinder and so on. That is, the main pipe 4a connected to the main control valve 11 and the main pipe 4b fixed to the boom 3 are jointly connected together by the socket 10.

In other words, in order to supply and control the hydraulic fluid to the arm cylinder of the excavator, the lower side of the main pipe 4 is jointly connected to the main control valve 11 mounted on the upper swing structure 2, and the upper side of the main pipe 4, which is fixed to the boom 3, is jointly connected to the arm cylinder.

As described above, in the case where the diameter of the main pipe 4 is extended due to the trend of large-scale zero tail swing equipment, the intermediate sides of the main pipes 4 are dividedly formed and jointly connected together by the socket 10, and thus a worker can easily assemble and install the main pipes 4 alone even in a narrow space between the upper swing structure 2 and the boom 3 due to the characteristic of the equipment.

Accordingly, the hydraulic fluid, which is fed from a hydraulic pump (not illustrated) and passes through the main control valve 11, is supplied to the arm cylinder of the excavator along the main pipes 4 (4a and 4b), and the working device can be driven.

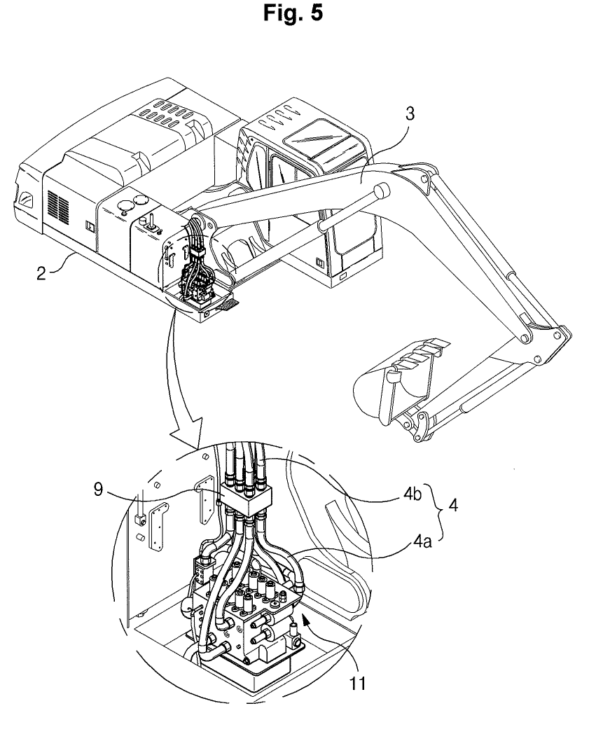

As illustrated in FIG. 5, an apparatus for fixing hydraulic pipes for a zero tail swing excavator according to another embodiment of the present invention includes a lower driving structure, an upper swing structure mounted on the lower driving structure to be swiveled, and working devices fixed to the upper swing structure and having a boom, an arm, and a bucket driven by their hydraulic cylinders. The apparatus further includes boom fixing frames 7 which are mounted on the upper swing structure 2 and to which the boom 3 is rotatably fixed; and a block 9 for fixing main pipes, fixed to the boom fixing frames 7, for supplying hydraulic fluid to the hydraulic cylinders and jointly connecting the main pipes 4 (4a and 4b) of which intermediate sides are dividedly formed.

The block 9 for fixing the main pipes may be mounted on outer surfaces of the boom fixing frames.

In this case, the construction except for the block 9 for fixing main pipes, mounted to external surfaces of the boom fixing frames 7, for jointly connecting the intermediate sides of the main pipes 4 dividedly formed, is substantially the same as the construction of the apparatus for fixing main pipes for a zero tail swing excavator according to an embodiment of the present invention as illustrated in FIGS. 3 and 4, and thus the detailed description thereof will be omitted. In the following description of the present invention, the same drawing reference numerals are used for the same elements across various figures.

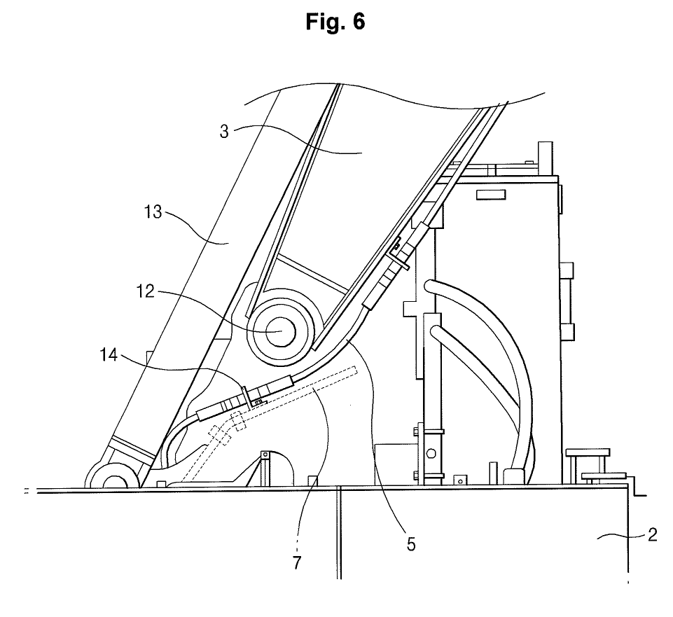

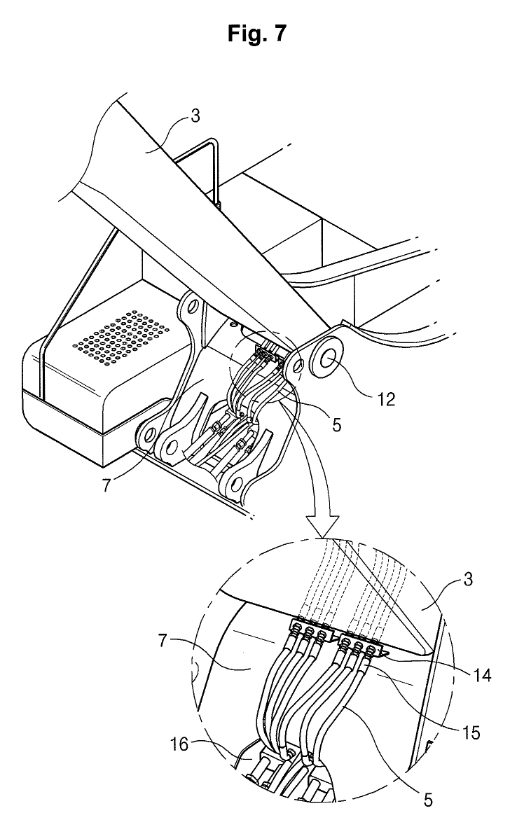

As illustrated in FIGS. 6 and 7, an apparatus for fixing hydraulic pipes for a zero tail swing excavator according to still another embodiment of the present invention includes a lower driving structure, an upper swing structure mounted on the lower driving structure to be swiveled, and working devices fixed to the upper swing structure and having a boom, an arm, and a bucket driven by their hydraulic cylinders. The apparatus further includes boom fixing frames 7 which are mounted on the upper swing structure 2 and to which the boom 3 is rotatably fixed; and a bracket 14 for fixing option pipes, which is fixed to the boom fixing frames 7 and to which hydraulic pipes 5 for option devices are fixed; wherein, if the boom 3 ascends at its maximum height or descends, a radius of curvature of the hydraulic pipes 5 for option devices which are fixed to the bracket 14 for fixing the option pipes neighbors a fixing pin 12 of the boom 3 to be minimized.

In a preferred embodiment of the present invention, the hydraulic pipes 5 for option devices are jointly connected by a block (not illustrated), and are fixed to the bracket 14 for fixing the option pipes.

The hydraulic pipes 5 for option devices are jointly connected by a connector 15, and are fixed to the bracket 14 for fixing the option pipes.

The hydraulic pipes 5 for option devices are fixed to either of upper surfaces or bottom surfaces of the boom fixing frames 7.

Hereinafter, the operation of the apparatus for fixing hydraulic pipes for a zero tail swing excavator according to still another embodiment of the present invention will be described with reference to the accompanying drawings.

As illustrated in FIGS. 6 and 7, in order to mount an option device, such as a breaker, after taking away a bucket from a front end of a working device (e.g. an arm) in accordance with working conditions, the hydraulic pipes 5 for supplying hydraulic fluid to the option device is fixed to the option device together with the main pipes. In this case, several hydraulic pipes 5 for option devices are mounted so that diverse kinds of option devices can be mounted and connected thereto.

Since the hydraulic pipes for option devices are fixed to the boom 3 and the radius of curvature of the hydraulic pipes 5 for option devices is minimized so that hydraulic fluid can be supplied to the option device, the boom 3 is prevented from interfering with neighboring components mounted on the upper swing structure 2 neighboring the lower end part of the boom even if the boom ascends at its maximum height or descends.

In order to control the hydraulic fluid being supplied to the option device, the lower end parts of the hydraulic pipes 5 for option devices are connected to the main control valve mounted on the upper swing structure 2. In this case, the hydraulic pipes 5 for option devices are connected to the main control valve, after passing through holes 16 formed to connect the boom cylinder 13 to the main pipes.

On the other hand, the upper end parts of the hydraulic pipes 5 for option devices connected to the option devices are fixed to be close to the upper surface of the rear side of the boom 3, after passing through the bracket 10 for fixing the option pipes that are formed on the boom fixing frames 7 supporting the boom 3. In this case, in accordance with the specification or the model number of the equipment, the hydraulic pipes 5 for option devices can be fixed to an upper side or a lower side of the bracket 10 for fixing the option pipes.

The hydraulic pipes 5 for option devices is to jointly connect the pipes of the main control valve side to the pipes of the option device side through the connector 11 or a block fixed to the bracket 10 for fixing the option pipes.

As described above, since the hydraulic pipes 5 for option devices are fixed to an upper surface of the rear side of the boom 3, the external appearance of the equipment is excellent. Also, the hydraulic pipes 5 for option devices, which come down from the option devices to the upper swing structure 3, are assembled without passing through the upper swing structure 2, and thus the assembly and maintenance of the hydraulic pipes 5 for option devices can be improved.

As described above, the apparatus for fixing hydraulic pipes for a zero tail swing excavator according to the embodiments of the present invention has the following advantages.

The process of assembling and installing the hydraulic pipes is simplified in a manner that the intermediate sides of the hydraulic pipes are dividedly formed and are jointly connected by a connection means, and thus the working efficiency of the equipment can be improved.

Since the work process for assembling and installing the main pipes having a large diameter in a narrow space between the boom and the upper swing structure due to the characteristic of the zero tail swing excavator is simplified, the work time can be shortened and the worker's safety can be secured.

Also, in the case of fixing the option pipes to the working devices so that the option devices can be replaced and used in the working device in accordance with working conditions, the radius of curvature of the option pipes becomes minimized when the boom ascends at its maximum height or descends, and thus various kinds of option pipes can be installed and assembled in a narrow space of an upper swing structure with the length of the hydraulic pipes shortened.

Also, as the hydraulic pipes for option devices are arranged on the rear side of the boom, the external appearance of the equipment is excellent. Also, since the main pipes and the option pipes are fixed to the boom, without passing through the upper swing structure, the assembly and maintenance thereof can be improved.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An apparatus for fixing hydraulic pipes for a zero tail swing excavator, including a lower driving structure, an upper swing structure mounted on the lower driving structure to be swiveled, and working devices fixed to the upper swing structure and having a boom, an arm, and a bucket driven by their hydraulic cylinders, the apparatus comprising:
boom fixing frames which are mounted on the upper swing structure and to which the boom is rotatably fixed;
main pipes for supplying hydraulic fluid to the hydraulic cylinders, intermediate sides of the main pipes being dividedly formed and being jointly connected by a socket; and
a bracket for fixing the main pipes, which is fixed to the boom fixing frames and to which the socket is fixed.

2. An apparatus for fixing hydraulic pipes for a zero tail swing excavator, including a lower driving structure, an upper swing structure mounted on the lower driving structure to be swiveled, and working devices fixed to the upper swing structure and having a boom, an arm, and a bucket driven by their hydraulic cylinders, the apparatus comprising:
boom fixing frames which are mounted on the upper swing structure and to which the boom is rotatably fixed; and
a block for fixing main pipes, fixed to the boom fixing frames, for supplying hydraulic fluid to the hydraulic cylinders and jointly connecting the main pipes of which intermediate sides are dividedly formed.

3. The apparatus of claim 1, wherein the bracket for fixing the main pipes is mounted on outer surfaces of the boom fixing frames.

4. The apparatus of claim 2, wherein the block for fixing the main pipes is mounted on outer surfaces of the boom fixing frames.

5. An apparatus for fixing hydraulic pipes for a zero tail swing excavator, including a lower driving structure, an upper swing structure mounted on the lower driving structure to be swiveled, and working devices fixed to the upper swing structure and having a boom, an arm, and a bucket driven by their hydraulic cylinders, the apparatus comprising:
boom fixing frames which are mounted on the upper swing structure and to which the boom is rotatably fixed; and
a bracket for fixing option pipes, which is fixed to the boom fixing frames and to which hydraulic pipes for option devices are fixed;
wherein, if the boom ascends at its maximum height or descends, it neighbors the hydraulic pipes for option devices and a fixing pin of the boom, and a radius of curvature of the hydraulic pipes for option devices, which are fixed to the bracket for fixing the option pipes, is minimized.

6. The apparatus of claim 5, wherein the hydraulic pipes for option devices are jointly connected by a separate block, and are fixed to the bracket for fixing the option pipes.

7. The apparatus of claim 5, wherein the hydraulic pipes for option devices are jointly connected by a separate connector, and are fixed to the bracket for fixing the option pipes.

8. The apparatus of claim 5, wherein the hydraulic pipes for option devices are fixed to either of upper surfaces or bottom surfaces of the boom fixing frames.
